(19) United States
(12) Patent Application Publication
(10) Pub. No.: US 2019/0353383 A1
(43) Pub. Date: Nov. 21, 2019

(54) HVAC OCCUPANCY DEPENDENT DYNAMIC AIRFLOW ADJUSTMENT SYSTEMS AND METHODS

(71) Applicant: Johnson Controls Technology Company, Auburn Hills, MI (US)

(72) Inventors: Tyler P. McCune, El Dorado, KS (US); Theresa N. Gillette, Wichita, KS (US); Jonathan A. Burns, Wichita, KS (US)

(21) Appl. No.: 15/988,829

(22) Filed: May 24, 2018

Related U.S. Application Data
(60) Provisional application No. 62/673,367, filed on May 18, 2018.

(51) Int. Cl. F24F 11/65; F24F 11/54; F24F 11/56; F24F 11/64; F24F 11/74; G05B 15/02

(52) U.S. Cl. CPC F24F 11/65; F24F 11/54; F24F 11/56; F24F 2120/10; F24F 11/74; G05B 15/02; F24F 11/64

(57) ABSTRACT

The present disclosure includes a heating, ventilation, and air conditioning (HVAC) system having a zone control panel implemented to control operation of equipment in the HVAC system. The zone control panel may determine occupancy and/or an indication of occupancy of a space in the HVAC system based at least in part on motion detected by an occupancy sensor. Accordingly, the zone control panel may control the operation of the equipment based at least in part on information received from an occupancy sensor. As such, the zone control panel may more rapidly condition air and/or more suitably adjust the airflow to an occupied space in comparison with an unoccupied space.

### CROSS-REFERENCE TO RELATED APPLICATIONS

This application is a Non-Provisional patent application of U.S. Provisional Patent Application No. 62/673,367, entitled “HVAC Occupancy Dependent Dynamic Airflow Adjustment Systems and Methods”, filed May 18, 2018, which is herein incorporated in its entirety for all purposes.

### BACKGROUND

The present disclosure generally relates to heating, ventilation, and air conditioning (HVAC) systems and, more particularly, to adaptively controlling airflow provided by an HVAC system.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, and air conditioning (HVAC) systems are often deployed in buildings to facilitate controlling air conditions, such as temperature and/or humidity, within the buildings. For example, an HVAC system may include equipment, such as an HVAC unit, which operates to produce temperature-controlled air that is supplied to and/or circulated through internal spaces of a building. To facilitate controlling the air conditions within a building, an HVAC system may control operation of its HVAC equipment based at least in part on a temperature setpoint or a target temperature associated with the internal space. For example, when measured temperature within the internal space is greater than the temperature setpoint by more than a threshold, the HVAC system may turn on or run the HVAC unit to extract heat from supply air to be provided to the internal space to facilitate cooling the internal space.

Additionally, to facilitate improving control granularity, in some instances, a building may be divided into multiple zones that is each associated with individually adjustable target air conditions, such as a target air temperature and/or a target humidity level. Based at least in part on deviation of measured air conditions from the target air conditions, the HVAC system may selectively provide supply air output from the HVAC unit to one or more building zone. For example, to control supply of air to a building zone, the HVAC system may execute a control algorithm to adjust damper position of one or more air dampers disposed in ductwork fluidly coupled between the HVAC unit and the building zone.

However, changes in air conditions are generally not instantaneous and, instead, occur gradually over a period of time. Moreover, the rate of change may be dependent on various factors, such as amount of supply air provided to a building zone, temperature retention characteristics of the building zone, and/or heat production in the building zone. In other words, at least in some instances, providing supply air to a building zone may result in varying changes to air conditions in the building zone, for example, compared to providing the supply air to a different building zone and/or at a different point in time. As such, at least in some instances, likelihood that actual air conditions present in a building zone perceivably or noticeably deviate from associated target air conditions and, thus, performance of the HVAC system may be dependent on ability of its control algorithm to account for the various factors.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an HVAC system includes a first occupancy sensor disposed in a first zone of a building serviced by the HVAC system to indicate that the first zone is occupied when the first occupancy sensor detects occurrence of a first motion in the first zone followed by a second motion in the first zone that occurs within a first duration after the first motion. The HVAC system further includes a control panel communicatively coupled to the first occupancy sensor that controls operation of equipment implemented in the HVAC system. Further, the control panel includes a microcontroller programmed to determine whether a first difference between a first measured climate condition in the first zone and a first target climate condition associated with the first zone is greater than a difference threshold. When the first difference between the first measured climate condition and the first target climate condition is greater than the difference threshold, the microcontroller is programmed to instruct the equipment to provide first conditioned air produced by the HVAC system to the first zone at a first rate when the first occupancy sensor does not indicate that the first zone is occupied. When the first difference between the first measured climate condition and the first target climate condition is greater than the difference threshold, the microcontroller further is programmed to instruct the equipment to provide the first conditioned air produced by the HVAC system to the first zone at a second rate greater than the first rate when the first occupancy sensor indicates that the first zone is occupied.

In another embodiment, a method to control operation of equipment in an HVAC system includes indicating, using a first occupancy sensor disposed in a first zone of a building serviced by the HVAC system, that the first zone is occupied when the first occupancy sensor detects occurrence of a first motion in the first zone followed by a second motion in the first zone that occurs within a first duration after the first motion. The method further includes determining, using one or more processors in the HVAC system, whether a first difference between a first measured climate condition in the first zone and a first target climate condition associated with the first zone is greater than a difference threshold. Further, the method includes, when the first difference between the first measured climate condition and the first target climate condition is greater than the difference threshold, instructing, using the one or more processors, equipment in the HVAC system to provide first conditioned air produced by the HVAC system to the first zone at a first rate when the first occupancy sensor does not indicate that the first zone is occupied. The method additionally includes, when the first difference between the first measured climate condition and the first target climate condition is greater than the difference threshold instructing, using the one or more processors, the equipment to provide the first conditioned air produced by the HVAC system to the first zone at a second rate greater than the first rate when the first occupancy sensor indicates that the first zone is occupied.

In another embodiment, a tangible, non-transitory, machine-readable medium, comprising machine-readable instructions executable by at least one processor of a control system in an HVAC system that, when executed by the at least one processor, cause the at least one processor to determine whether a first occupancy sensor indicates that a first zone of a building serviced by the HVAC system is occupied, where the first occupancy sensor is disposed in the first zone and indicates that the first zone is occupied when the first occupancy sensor detects occurrence of a first motion in the first zone followed by a second motion in the first zone within a first duration after the first motion. The instructions, when executed, further cause the at least one processor to determine whether a first difference between a first measured climate condition in the first zone and a first target climate condition associated with the first zone is greater than a difference threshold. Further, when the first difference between the first measured climate condition and the first target climate condition is greater than the difference threshold, the instructions, when executed, cause the at least one processor to instruct equipment in the HVAC system to provide first conditioned air produced by the HVAC system to the first zone at a first rate when the first occupancy sensor does not indicate that the first zone is occupied. Additionally, when the first difference between the first measured climate condition and the first target climate condition is greater than the difference threshold, the instructions, when executed, cause the at least one processor to instruct the equipment to provide the first conditioned air produced by the HVAC system to the first zone at a second rate greater than the first rate when the first occupancy sensor indicates that the first zone is occupied.

### BRIEF DESCRIPTION OF THE DRAWINGS

Various aspects of the present disclosure may be better understood upon reading the following detailed description and upon reference to the drawings, in which:

FIG. 1 illustrates a heating, ventilating, and air conditioning (HVAC) system for building environmental management that may employ one or more HVAC units, in accordance with an embodiment of the present disclosure;

FIG. 2 is a perspective view of a HVAC unit of the HVAC system of FIG. 1, in accordance with an embodiment of the present disclosure;

FIG. 3 illustrates a residential heating and cooling system, in accordance with an embodiment of the present disclosure;

FIG. 4 illustrates a vapor compression system that may be used in the HVAC system of FIG. 1 and in the residential heating and cooling system of FIG. 3, in accordance with an embodiment of the present disclosure;

FIG. 5 is a block diagram of a portion of the HVAC system of FIG. 1 including a an occupancy sensor, in accordance with an embodiment of the present disclosure;

FIG. 6 is a flow diagram of a process for controlling operation of the portion of the HVAC system of FIG. 5, in accordance with an embodiment of the present disclosure; and

FIG. 7 is a flow diagram of a process for detecting relevant motion using the occupancy sensor of FIG. 5, in accordance with an embodiment of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As will be discussed in further detail below, heating, ventilation, and air conditioning (HVAC) systems often utilize a control system to control the operation of devices or equipment within the HVAC system, for example, implemented via one or more zone control boards or panels. That is, a zone control panel may receive input data or signals from one or more devices in the HVAC system, such as an interface device, a thermostat, a sensor, another zone control panel, or any combination thereof. Additionally or alternatively, a zone control panel may output control commands or signals that instruct one or more other devices in the HVAC system to perform control actions. For example, a zone control panel may receive a temperature setpoint via a thermostat, compare the temperature setpoint to a temperature measurement received from a sensor, and instruct equipment in the HVAC system to adjust operation when the temperature measurement deviates from the temperature setpoint by more than a threshold amount.

Further, to more suitably address demand for conditioned air, which may result from a difference between the measured temperature and a corresponding temperature set point, the zone control panel may determine occupancy and/or an indication of occupancy based at least in part on motion detected by an occupancy sensor. More specifically, in some embodiments, the zone control panel may more rapidly address a demand for conditioned air in an occupied space than in an unoccupied space based at least in part on information received from an occupancy sensor. To do so, the zone control panel may more rapidly condition air and/or more suitably adjust the airflow to an occupied space in comparison with an unoccupied space.

Accordingly, the present disclosure provides techniques to facilitate improving control granularity and/or to facilitate reducing energy consumption resulting from operation of an HVAC system. For example, by interfacing with the occupancy sensors, the zone control panel may receive sensor data indicative of occupancy within one or more zones in a building serviced by the HVAC system. Based at least in part on the occupancy information, the zone control panel may adaptively or dynamically adjust airflow supplied to calling building zones. For example, the zone control panel may determine target damper position of air dampers disposed in ductwork of the building by executing a control algorithm that directly factors in occupancy within the various building zones.

In some embodiments, the target damper positions determined by executing the control algorithm may result in more supply air being provided to occupied building zones, for example, compared to unoccupied or less occupied building zones. In other words, in some embodiments, the zone control panel may take into account occupancy in each of multiple building zones, which, at least in some instances, may facilitate improving control granularity provided by the control panel. Additionally, increasing amount of supply air provided to an occupied building zone may facilitate reducing duration before its demand is met, which, at least in some instances, may facilitate reducing likelihood that actual air conditions perceivably or noticeably deviate from associated target air conditions. Further, by more rapidly meeting demands in an occupied space and taking, in comparison, additional time to meet demands in an unoccupied space, the energy consumed by the HVAC system may be reduced and the HVAC system may be provided with greater operational flexibility.

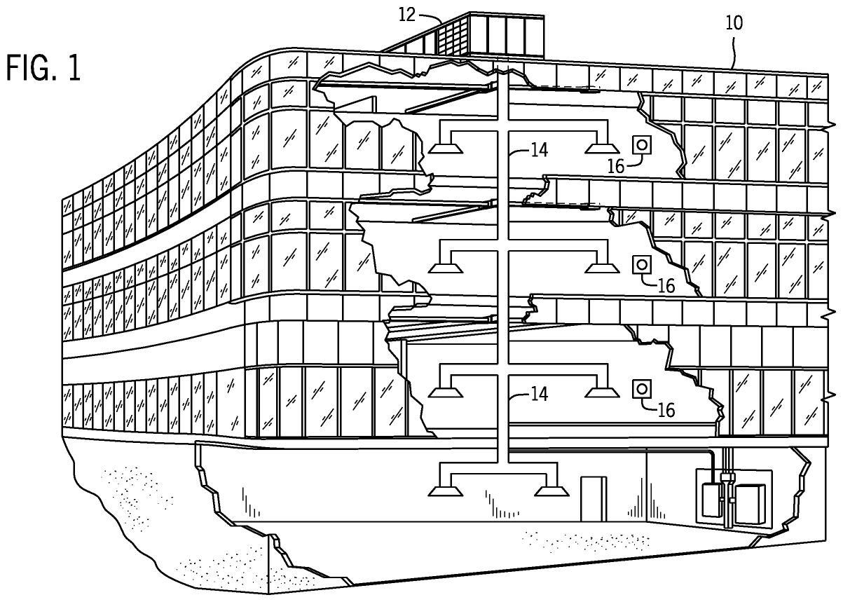

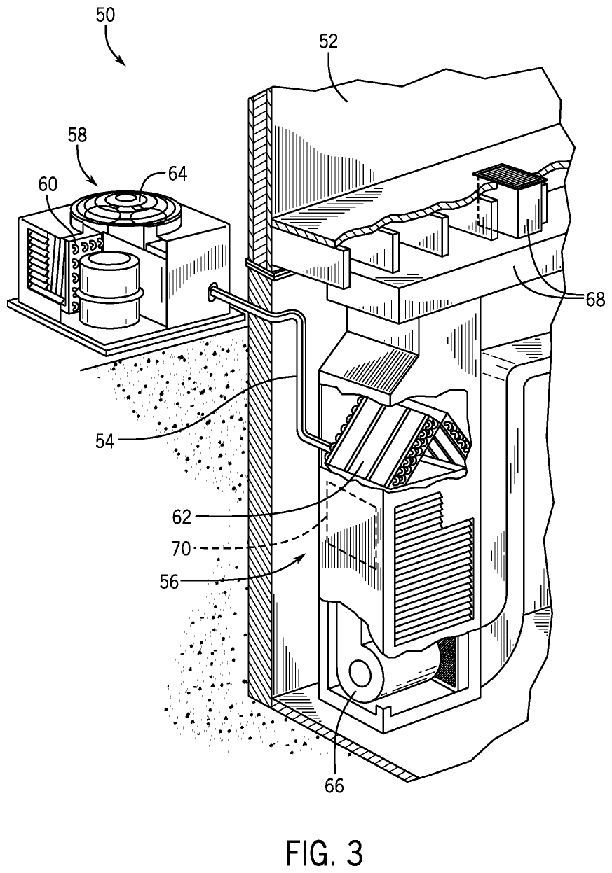

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

In any case, the HVAC unit 12 may be air cooled device that implements a refrigeration cycle to provide conditioned air to the building 10. For example, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the air is conditioned, then HVAC unit 12 may supply the conditioned air to the building 10 via ductwork 14 extending throughout the building 10 from the HVAC unit 12. For example, the ductwork 14 may extend to various individual floors or other sections of the building 10. In some embodiments, the HVAC unit 12 may be a heat pump that provides both heating and cooling to the building 10, for example, with one refrigeration circuit implemented to operate in multiple different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and/or the like. Moreover, the control device 16 may include computer systems that are integrated with or separate from other building control or monitoring systems, and even systems that are remote from the building 10.

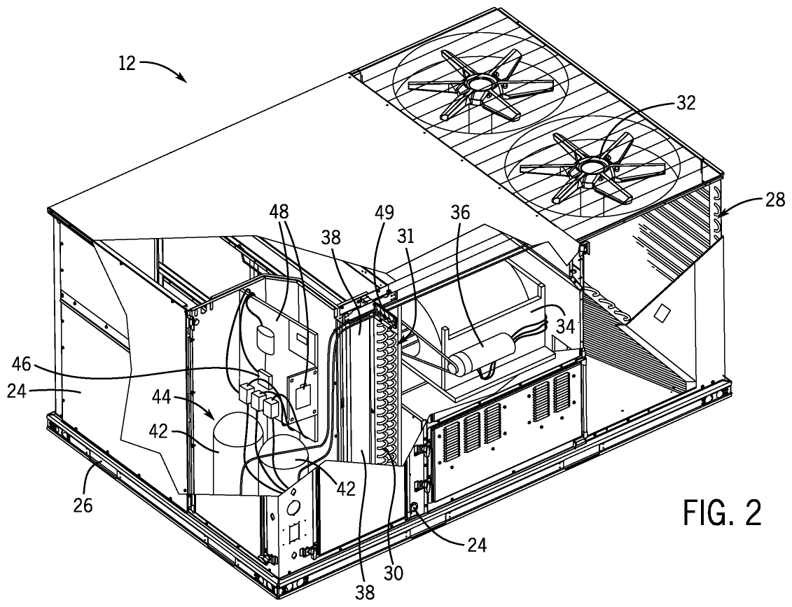

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, and/or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and may provide structural support and/or protection to the internal components from environmental and/or other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements, such as rain, from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and/or the like. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream.

In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 may draw air from the environment through the heat exchanger 28. Air may be heated and/or cooled as the air flows through the heat exchanger 28 before being released back to the environment surrounding the rooftop unit 12. A blower assembly 34, powered by a motor 36, may draw air through the heat exchanger 30 to heat or cool the air. The heated or cooled air may be directed to the building 10 by the ductwork 14, which may be connected to the HVAC unit 12. Before flowing through the heat exchanger 30, the conditioned air may flow through one or more filters 38 that may remove particulates and/or other contaminants from the air. In certain embodiments, the filters 38 may be disposed on the air intake side of the heat exchanger 30 to reduce likelihood of contaminants contacting the heat exchanger 30.

The HVAC unit 12 also may include other equipment for implementing the thermal cycle. Compressors 42 may increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and/or devices may be included in the HVAC unit 12, such as a solid-core filter drier, a drain pan, a disconnect switch, an economizer, pressure switches, phase monitors, and humidity sensors, among other things.

The HVAC unit 12 may receive electrical power via a terminal block 46. For example, a high voltage power source may be connected to the terminal block 46 to power the equipment. The operation of the HVAC unit 12 may be governed or regulated by a control board 48. The control board 48 may include control circuitry connected to a thermostat, a sensor, and/or an alarm. One or more of these components may be referred to herein separately or collectively as the control device 16. The control circuitry may be implemented to control operation of the equipment, provide alarms, and/or monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and/or air filters. In the illustrated embodiment, the residential heating and cooling system 50 is a split HVAC system. In general, a residence 52 conditioned by a split HVAC system may include refrigerant conduits 54 that operatively couple the indoor HVAC unit 56 to the outdoor HVAC unit 58. The indoor HVAC unit 56 may be positioned in a utility room, an attic, a basement, and/or the like. The outdoor HVAC unit 58 is typically situated adjacent to a side of residence 52 and is covered by a shroud to protect the system components and to reduce likelihood of leaves and/or other debris or contaminants from entering the unit. The refrigerant conduits 54 may transfer refrigerant between the indoor HVAC unit 56 and the outdoor HVAC unit 58, typically transferring primarily liquid refrigerant in one direction and primarily vaporized refrigerant in an opposite direction.

When the system shown in FIG. 3 is operating as an air conditioner, a heat exchanger 60 in the outdoor HVAC unit 58 may serve as a condenser for re-condensing vaporized refrigerant flowing from the indoor HVAC unit 56 to the outdoor HVAC unit 58 via one of the refrigerant conduits 54. In these applications, a heat exchanger 62 of the indoor unit may function as an evaporator. Specifically, the heat exchanger 62 receives liquid refrigerant, which may be expanded by an expansion device, and evaporates the refrigerant before returning it to the outdoor HVAC unit 58.

The outdoor HVAC unit 58 may draw environmental air through the heat exchanger 60 using a fan 64 and expel the air above the outdoor HVAC unit 58. When operating as an air conditioner, the air is heated by the heat exchanger 60 within the outdoor HVAC unit 58 exits the unit at a temperature higher than it entered. The indoor HVAC unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the setpoint on the thermostat, or the setpoint plus a small amount, the residential heating and cooling system 50 may become operative to refrigerate or cool additional air for circulation through the residence 52. When the temperature reaches the setpoint, or the setpoint minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor HVAC unit 58 may serve as an evaporator to evaporate refrigerant, thereby cooling air entering the outdoor HVAC unit 58 as the air passes over outdoor the heat exchanger 60. The indoor heat exchanger 62 may receive a stream of air blown over it and heat the air by condensing the refrigerant.

In some embodiments, the indoor HVAC unit 56 may include a furnace system 70. For example, the indoor HVAC unit 56 may include the furnace system 70 when the residential heating and cooling system 50 is not implemented to operate as a heat pump. The furnace system 70 may include a burner assembly and heat exchanger, among other components, inside the indoor HVAC unit 56. Fuel may be provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

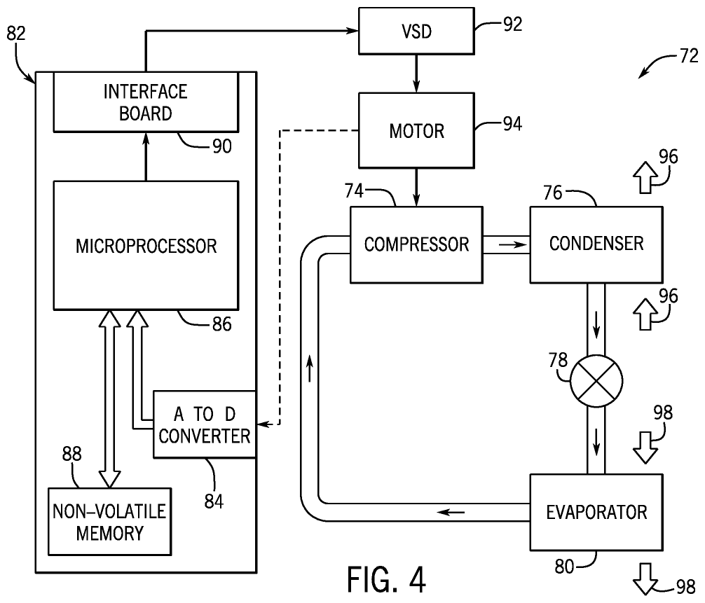

FIG. 4 is an embodiment of a vapor compression system 72 that can be used in any of the systems described above. The vapor compression system 72 may circulate a refrigerant through a circuit starting with a compressor 74. The circuit may also include a condenser 76, one or more expansion valves or devices 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. In some embodiments, the VSD 92 may receive alternating current (AC) power having a particular fixed line voltage and fixed line frequency from an AC power source, and provide power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator 80 relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC system. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

The description above with reference FIGS. 1-4 is intended to be illustrative of the context of the present disclosure. The techniques of the present disclosure may update features of the description above. In particular, as will be discussed in more detail below, one or more occupancy sensors, may be implemented in the HVAC system, for example, to facilitate improving control granularity and/or to reduce energy consumption.

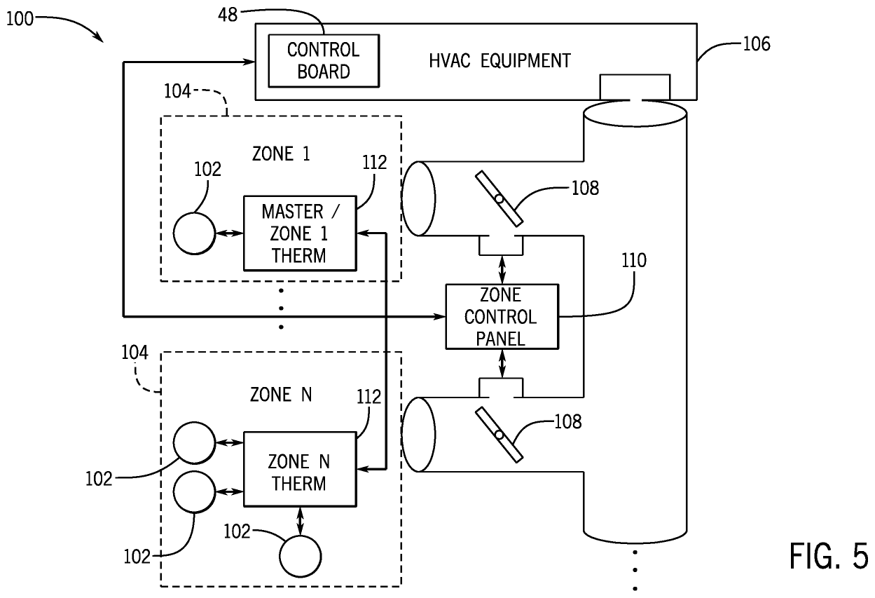

To help illustrate, an HVAC system 100 that includes an occupancy sensor 102 is shown in FIG. 5. The occupancy sensor 102 may include any suitable combination of a motion detection sensor, infrared sensor, ultrasonic sensor, a camera, and/or the like capable of detecting motion and/or occupancy in an area, such as a zone 104 or space in a building. To do so, the occupancy sensor 102 may use changes in infrared signals, ultrasonic signals, and/or image data transmitted and/or received from the occupancy sensor 102.

Accordingly, in some embodiments, the occupancy sensor 102 may detect motion and estimate occupancy in an area, such as a zone 104, based at least in part on the detected motion. That is, for example, motion detection may be used as an indicator of occupancy, number of occupants, and/or level of activity in the area. Further, to capture motion within all or a portion of the area, the occupancy sensors 102 may be arranged or positioned in a suitable manner. For example, the occupancy sensors 102 may be located at suitable height, such as on the ceiling, four feet off the floor, and/or the like, to reduce likelihood of a blocked range, which may result from furniture and/or other objects within the area. Additionally or alternatively, two or more occupancy sensors 102 may be disposed in the same area to have overlapping ranges, which, at least in some instances may reduce likelihood of motion occurring within the area going undetected.

Moreover, in some embodiments, an occupancy sensor 102 may be a stand-alone device. Additionally or alternatively, an occupancy sensor 102 may be integrated with additional equipment in the HVAC system 100, such as a zone thermostat 112. In fact, in some embodiments, occupancy sensors 102 implemented in a building zone may include a combination of an integrated occupancy sensor 102 with one or more stand-alone occupancy sensors 102.

In any case, the occupancy sensor 102 may communicate with a zone control panel 110 and/or a zone thermostat 112 to control airflow to the one or more zones 104, for example, via a wireless connection and/or a wired connection. As described herein, the zone control panel 110 may govern operation of HVAC equipment 106, such as the HVAC unit 12 or the vapor compression system 72, and/or of one or more air dampers 108. As such, the zone control panel 110 may control production of supply air and/or supply of the air to one or more zones 104. More specifically, in some embodiments, the zone control panel 110 may receive input from one or more sensors and/or zone thermostats 112, in the HVAC system 100, such as within each of the zones 104, and may determine how to condition air and where (e.g., which zones 104) to deliver the conditioned air to within the HVAC system 100.

Moreover, the illustrated embodiment is intended to be illustrative and not limiting. Accordingly, while the illustrated embodiment demonstrates the occupancy sensor 102 in direct communication with a zone thermostat 112 via a wireless connection and/or a wired connection, the occupancy sensor may additionally or alternatively communicate directly with the zone control panel 110, as discussed above. In any case, the zone thermostat 112 may communicate information to the zone control panel 110. Accordingly, in some embodiments, the zone thermostat 112 may relay information related to the occupancy sensor 102 to the zone control panel 110. Further, while operations described herein, such as receiving or determining information, controlling operation of HVAC equipment 106, and/or the like, may be described as implemented by the zone control panel 110 or the zone thermostat 112, the zone control panel 110, the zone thermostat 112, or a combination thereof, may handle any of the operations.

To determine where and/or how to deliver conditioned air, the zone control panel 110 may determine a respective demand, if one exists, associated with each of the zones 104 serviced by the HVAC system 100 based at least in part on the inputs from the one or more sensors and/or thermostats. That is, for example, the zone control panel 110 may determine a differential in a zone 104 between a measured temperature, which may be determined by a corresponding zone thermostat 112 or zone sensor, and a target temperature associated with the zone, which may be set via the corresponding zone thermostat 112 or zone sensor. Additionally, if the differential exceeds a certain threshold, such as 2° F., the zone control panel 110 may determine suitable airflow for the zone 104 based at least in part on the differential, for example, by executing a control algorithm to determine target position of air dampers 108.

In some embodiments, the zone control panel 110 may further use information, such as the size of a zone 104 and/or a maximum airflow suitable to deliver to the zone, which may each be configured via the zone control panel 110, to determine suitable airflow for the HVAC system 100. Further, the zone control panel 110 may determine a default airflow, which may be configured and/or specified by a manufacturer and/or a system integrator of the HVAC system 100, for each zone 104. In any case, the zone control panel 110 may use any combination of information, as described above, to determine a method of controlling HVAC equipment 106 to condition and deliver conditioned air.

Additionally or alternatively, the control of the HVAC equipment 106 in the zone control panel 110 may be modified to use motion detection information, as may be captured with the occupancy sensor 102. In such embodiments, the zone control panel 110 may use a normal procedure, as described above, to control operation of HVAC equipment 106 when no motion has been detected in the HVAC system 100 and/or when occupancy sensors 102 are not in use in the HVAC system 100. On the other hand, the zone control panel 110 may use a motion-based procedure to control operation of the HVAC equipment 106 when motion is detected by an occupancy sensor 102. In this manner, the HVAC system 100 may be controlled with increased granularity and/or operational flexibility.

Further, by using the motion-based procedure, the zone control panel 110 may control operation of the HVAC equipment 106 to facilitate more rapidly meeting and/or detecting demand in a first zone 104 having detected motion, which may be indicative of occupancy in the first zone 104 than for a second zone 104 lacking motion. Because demand in an occupied zone 104 may be met more rapidly than an unoccupied zone, an occupant in the first zone 104 may adjust the set point and/or expected climate conditions of the first zone 104 with reduced frequency, which may reduce stress on the HVAC system 110. Further, according to the motion-based procedure, by reducing the airflow and/or level of conditioning of air provided to a zone 104 lacking occupants and/or detected motion, the energy consumed by the HVAC system 100 may be reduced.

Accordingly, based at least in part on the occupancy and/or motion within a particular zone 104, which may be detected with one or more occupancy sensors 102 within the zone 104, the zone control panel 110 may instruct HVAC equipment 106, such as one or more air dampers 108, the blower 66, and/or the like, to increase or decrease airflow to the zone 104 and/or to the other zones 104 in the HVAC system 100. Thus, in some embodiments, the HVAC system 100 may more rapidly adjust climate or air conditions in a zone 104 having motion detected by an occupancy sensor 102 than for a zone 104 lacking motion detected by an occupancy sensor 102. For example, if an occupancy sensor 102 in a first zone 104 detects motion and/or an occupant in the first zone 104, the zone control panel 110 may instruct HVAC equipment 106 to increase airflow to the first zone 104 to rapidly reach a temperature set point and/or another specified condition. On the other hand, for a second zone 104 lacking motion detected by an occupancy sensor 102, the zone control panel 110 may instruct HVAC equipment 106 to condition the second zone 104 in a manner to satisfy the temperature set point and/or another specified condition at a slower rate than the for the first zone 104.

To increase airflow to and/or to more rapidly meet demand in a zone 104 where motion is detected, the zone control panel 110 may perform any suitable combination of instructing HVAC equipment 106 to advance to a next stage of heating and/or cooling, instructing one or more air dampers 108 to adjust positions, and reducing the differential threshold used to initiate a call for conditioning. As described herein, the HVAC unit 12 may be capable of providing various stages of heating and/or cooling, where a first stage of heating, for example, may provide low heat, while a second stage of heating may provide high heat. Accordingly, instructing the HVAC equipment 106 to reach the next stage of heating and/or cooling more rapidly may involve instructing the HVAC unit 12 to operate in the next stage of heating and/or cooling at a lower temperature threshold than is used during normal operation before switching stages. As a result, the HVAC unit 12 may more rapidly condition (e.g., heat and/or cool) air that may be provided to a zone 104.

By instructing a first one or more air dampers 108 corresponding with a first zone 104 in which motion is detect to move to a more open position, the zone control panel 110 may facilitate increasing airflow provided to the first zone 104. In some embodiments, the zone control panel 110 may additionally or alternatively instruct a second one or more air dampers 108 corresponding to a second zone 104 in which motion is not detected to move to or maintain a more closed position, which may facilitate further increasing airflow provided to the first zone 104. Further, by reducing the differential threshold used to initiate calls for conditioning, the zone control panel 110 may identify demand associated with zone 104 with increased sensitivity and, as a result, may respond to smaller fluctuations in climate conditions present within the zone 104.

Further, when motion is not detected by any of the occupancy sensors 102 and/or after demand in each of the zones 104 having detected motion is met, the zone control panel 110 may return to a normal procedure to control of the operation of the HVAC equipment 106. That is, for example, the zone control panel 110 may control operation of the HVAC equipment 106 of an HVAC system 100 absent any motion and/or absent any occupants based on the information from one or more sensors and/or thermostats in the HVAC system 100 and may begin and/or return to controlling operation of the HVAC equipment 106 based on a motion-based procedure once additional motion is detected by an occupancy sensor 102.

Additionally or alternatively, the zone control panel 110 may implement the motion-based procedure, which may involve the zone control panel 110 factoring in motion detected by an occupancy sensor 102, in order to control HVAC equipment 106, based at least in part on a programmable schedule. Accordingly, during this period, the occupancy sensors 102 may be set to an idle, low-power, or off state during periods of the programmable schedule when the motion-based procedure is not in use and/or the zone control panel 110 may ignore any motion detected by the occupancy sensors 102. On the other hand, when motion-based procedure is used, the zone control panel 110 may appropriately control HVAC equipment 106 based at least in part on motion detected by the one or more occupancy sensors 102. To that end, during times when, for example, a zone 104 is expected to be unoccupied, the zone control panel 110 may use normal procedure to control the operation of the HVAC equipment 106 so that over-conditioning of the zone 104 and/or increased energy demands associated with increasing the airflow to the zone 104 based on motion detected in the zone may be reduced.

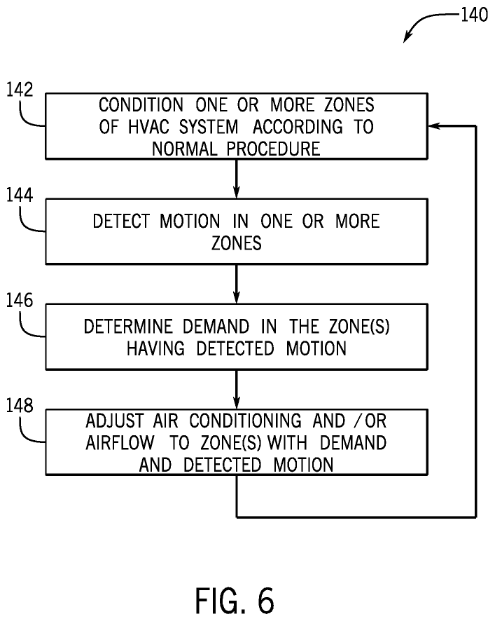

In any case, an example of a process 140 for controlling operation of an HVAC system 100 based on information determined by one or more occupancy sensors 102 is described in FIG. 6. Although the following description of the process 140 is described in a particular order, which represents a particular embodiment, it should be noted that the process 140 may be performed in any suitable order. Moreover, embodiments of the process 140 may omit process blocks and/or include suitable additional process blocks.

Generally, the process 140 includes conditioning the HVAC system 100 according to a conditioning procedure independent of motion and/or occupancy detection (process block 142), detecting motion in one or more zones 104 of the HVAC system 100 (process block 144), determining demand for conditioning one or more zones 104 with detected motion (process block 146), and modifying airflow provided to the one or more zones 104 with demand for conditioning and detected motion (process block 148). In some embodiments, the process 140 may be implemented at least in part by a suitable combination of an occupancy sensor 102, a zone control panel 110, and/or a manufacturer and/or a system integrator of the HVAC system 100. Additionally or alternatively, the process 140 may be implemented at least in part by executing instructions stored in a tangible, non-transitory, computer-readable medium, such as non-volatile memory 88, using processing circuitry, such as the microprocessor 85.

In any case, at process block 142, the HVAC system 100 controlling operation of its HVAC equipment 106 using a normal procedure, for example, independent of occupancy and/or motion detection. In other words, the zone control panel 110 may determine how to condition air and where to direct the conditioned air based in part on information from one or more sensors and/or zone thermostats 112 in the HVAC system 100 and may control the operation of the HVAC equipment 106 accordingly. Further, in some embodiments, the zone control panel 110 may cease receiving information related to motion and/or occupancy from the occupancy sensors 102 while using the normal procedure, for example, to facilitate reducing power consumption.

One or more occupancy sensors 102 may then detect motion and/or occupancy in one or more zones 104, at process block 144. To do so, the occupancy sensors 102 may use changes in infrared signals, ultrasonic signals, and/or image data captured by a camera. Further, as described herein, motion detected using an occupancy sensor 102 may be indicative of occupancy in an area, such as a zone 104, and, in some embodiments, the energy consumed by the HVAC system 100 may be reduced and/or the granularity of control over the HVAC system 100 may be increased by utilizing occupancy data received from the occupancy sensors 102 and/or derived from sensor data received from the occupancy sensors 102.

However, in some instances, motion detection may capture motion that is irrelevant to and/or not directly related to occupancy or to improving control of the HVAC system 100. For example, detecting the motion of an occupant leaving an area may not indicate that the area is still occupied. Thus, to improve the accuracy with which motion detection may indicate occupancy in an area and/or remain relevant to improving control of the HVAC system 100 (e.g., reducing energy consumption), certain motion detection thresholds may be implemented.

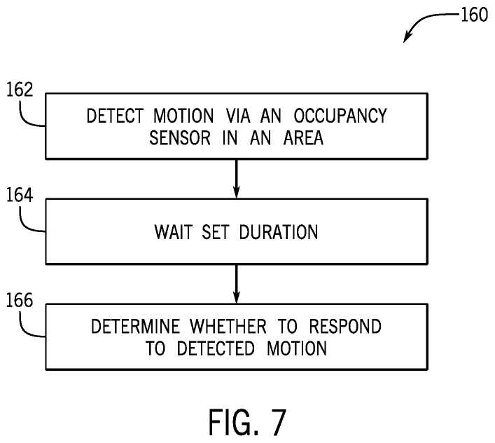

To help illustrate, an example of a process 160 for detecting motion indicative of occupancy and/or relevant to a motion-based procedure is described in FIG. 7. Although the following description of the process 160 is described in a particular order, which represents a particular embodiment, it should be noted that the process 160 may be performed in any suitable order. Moreover, embodiments of the process 160 may omit process blocks and/or include suitable additional process blocks.

Generally, the process 160 includes detecting motion in an area via an occupancy sensor (process block 162), waiting a set duration (process block 164), and determining whether to respond to the detected motion (process block 166). While the illustrated embodiment is described as being implemented by one or more occupancy sensors 102 and/or the zone control panel 110, any suitable components in the HVAC system 100 may be used. Additionally or alternatively, the process 160 may be implemented at least in part by executing instructions stored in a tangible, non-transitory, computer-readable medium, such as non-volatile memory 88, using processing circuitry, such as the microprocessor 85.

In any case, at process block 162, an occupancy sensor 102 may detect motion in an area, such as a zone 104 within a building 10. As described herein, detecting motion may involve a change in data and/or a signal, such as an infrared signal, an ultrasonic signal, image data, and/or the like, transmitted and/or received by the occupancy sensor 102 based at least in part on an object, such as an occupant, passing within a certain distance from the occupancy sensor 102. Further, in some embodiments, after detecting motion, the occupancy sensor 102 may communicate an indication of the detected motion to the zone control panel 110, for example, as an indication signal, sensor data, and/or occupancy data.

After detecting any motion and/or receiving an indication that motion has been detected, at process block 164, the occupancy sensor 102 and/or the zone control panel 110, respectively, may wait a set duration, for example, 2 seconds, 10 seconds, or longer. In some embodiments, this duration may be determined via one or both of the occupancy sensor 102 and the zone control panel 110. Further, by changing the duration, the occupancy sensor 102 and/or the zone control panel 110 may adaptively adjust its sensitivity to detected motion, as described in further detail below.

After the set duration has passed, at process block 166, the occupancy sensor 102 and/or the zone control panel 110 may determine whether to respond to the detected motion or whether the motion detected at process block 162 is relevant. To determine whether to respond to the detected motion, the occupancy sensor 102 and/or the zone control panel 110 may determine whether any additional motion has been detected during the duration and/or at the end of the duration. In some embodiments, the occupancy sensor and/or the zone control panel 110 may utilize a threshold amount or number of occurrences of motion captured within the duration. Additionally or alternatively, the occupancy sensor and/or the zone control panel 110 may use the duration as an interval after which, in order to respond to the detected motion, additional motion may also be detected.

In any case, additional motion may be detected by the occupancy sensor 102 and/or by another suitable occupancy sensor 102. That is, for example, the occupancy sensor 102 and/or the zone control panel 110 may determine whether additional motion was detected by another occupancy sensor in the same zone 104 as the occupancy sensor 102. Additionally or alternatively, based at least in part on an arrangement of one or more occupancy sensors 102 in the HVAC system 100, the occupancy sensor 102 and/or the zone control panel 110 may determine whether the additional motion is indicative of an occupant entering, existing, or remaining in an area, such as a zone 104, and may then determine whether to respond to the detected motion.

In some embodiments, to respond to detected motion, the occupancy sensor 102 may communicate to the zone control panel 110 that relevant motion has been detected. In such cases, the occupancy sensor 102 may be implemented to wait the set duration before determining whether to respond to the detected motion, for example, by communicating to the zone control panel 110 indicating that motion was detected. Additionally or alternatively, the zone control panel 110, after receiving notification via the occupancy sensor 102 that motion was detected, may wait the set duration and determine to respond to the detected motion by using the detected motion to adjust conditions, such as airflow, in the HVAC system 100 according to the motion-based procedure to control operation of HVAC equipment 106.

Returning now to the process 140 of FIG. 6, after motion is detected in one or more zones 104 and this motion has been determined to be relevant, the zone control panel 110, at process block 146, may operate according to the motion-based procedure to control operation of the HVAC equipment 106 and may determine demand in the one or more zones 104 having detected motion. Demand may include any suitable combination of calls for heating, cooling, changes in airflow, and/or any other suitable conditioning provided by the HVAC system 100.

Further, in some embodiments, the zone control panel 110 may determine the demand based at least in part on a comparison of measured conditions in the zone 104 with target conditions in the zone 104. For example, the zone control panel 110 may determine the demand based on a comparison of temperature measured in the zone 104 versus the temperature setpoint associated with the zone 104. As discussed herein, the zone control panel 110 may determine demand for a zone 104 having detected motion with increased sensitivity, for example, by adjusting differential thresholds used to initiate calls for conditioning. Additionally or alternatively, the zone control panel 110 may receive a request specifying demand for a zone 104, for example, from a manufacturer integrator of the HVAC system 100, a system integrator of the HVAC system 100, and/or an occupant of a building 10 serviced by the HVAC system 100.

For each of the zones 104 with detected motion and associated with a call for conditioning, at process block 148, the zone control panel 110 may adjust airflow delivered to the zones 104, which may result in a zone 104 with detected motion's demand being met more rapidly by the HVAC system 100, for example, compared to a zone 104 in which motion is not detected. In some embodiments, to adjust the airflow, the zone control panel 110 may instruct one or more air dampers 108 in a zone 104 to change position. More specifically, the zone control panel 110 may instruct the one or more air dampers 108 in the zone 104 to open fully or more fully, which may allow maximum airflow to the zone.

Additionally or alternatively, the zone control panel 110 may instruct one or more air dampers 108 in zones 104 in which motion is not detected to change position based at least in part on the respective demand of each of the zones 104 lacking detected motion. In some embodiments, for example, the zone control panel 110 may instruct one or more air dampers 108 associated with a first zone 104 lacking detected motion but having a demand to remain in or to move to a partly closed position, for example, 25% closed or 50% closed, so that the first zone 104 may receive reduced airflow in comparison with a second zone 104 having detected motion and demand. In such cases, because the first zone 104 may receive less airflow with its air dampers 108 in a partly closed position than the second zone 104 with its air dampers 108 in a more open position, the demand of the first zone 104 may be met after a longer duration than the demand of the second zone 104.

Further, for a zone 104 lacking detected motion and lacking demand, the zone control panel 110 may fully close the one or more air dampers 108 associated with the zone 104. Accordingly, little to no airflow may be delivered to the zone 104 lacking detected motion and lacking demand, and increased airflow may be delivered to a zone 104 with demand and/or to a zone 104 with demand and detected motion.

Further, since the zone control panel 110 may detect motion and demand in multiple zones 104, in some embodiments, the zone control panel 110 may fully open the respective air damper 108 associated with each of the zones 104 having demand and detected motion. Additionally or alternatively, the zone control panel 110 may fully open the respective air dampers 108 associated with a subset of the zones 104 having demand and detected motion. In such embodiments, for example, the zone control panel 110 may prioritize and/or determine a priority of zones 104 having demand and detected motion to determine the subset. This priority may be based at least in part on any suitable combination of an input received from a user, a level of demand associated with each of the zones 104, a level of motion detected in each of the zones 104, and/or the like.

In any case, the zone control panel 110 may more fully open the air dampers 108 associated with the subset of zones 104 having the highest priority and may open the respective air dampers 108 associated with the remaining zones 104 having demand and detected motion that are not in the subset to an alternate or less open position. Additionally or alternatively, once the demand for the subset of zones 104 is met and/or modified airflow has been provided to the subset of zones 104 for a threshold duration, as described in more detail below, the zone control panel 110 may more fully open the air dampers 108 associated with the remaining zones 104 having demand and detected motion. That is, the zone control panel 110 may delay adjusting the position of the air dampers 108 associated with the remaining zones 104 having demand and detected motion until some duration after the air dampers 108 associated with the subset of zones 104 are more fully opened.

In addition to or in the alternative of adjusting the airflow delivered to a zone 104 having detected motion, the zone control panel 110 may instruct the HVAC unit 12 to stage more rapidly from one heating and/or cooling stage to a different heating and/or cooling stage. Accordingly, the air delivered to the zone 104 having detected motion may be conditioned more rapidly so that the demand of the zone 104 may be approached more rapidly. For example, for a zone 104 having detected motion and a demand indicating the actual temperature of the zone 104 should be raised, the zone control panel 110 may instruct the HVAC unit 12 to rapidly switch from a cooling stage and/or a heating stage providing low heat to a heating stage providing high heat. Accordingly, air conditioned to have a higher temperature may be delivered to the zone 104 to more rapidly adjust the temperature of the zone 104 than air conditioned to have a lower temperature in comparison.

As described above, the zone control panel 110 may instruct the HVAC equipment 106 to provide the adjusted airflow and/or adjusted conditioning of the air to the zones 104 having detected motion and demand for a set duration and/or until a threshold of climate conditions in the zones 104 is reached. That is, for example, the effect of motion detection and/or occupancy in a zone 104 on the control of the operation of the HVAC equipment 106 may be limited by a duration and/or by an effectiveness of the adjusted airflow and/or adjusted conditioning at meeting expected climate conditions. For example, the zone control panel 110 may instruct the HVAC equipment 106 to supply the adjusted airflow and/or adjusted conditioning to a zone 104 having detected motion for a duration, such as 15 minutes, which may reduce likelihood of over conditioning of the zones 104.

In such cases, once the duration has elapsed, the zone control panel 110 may receive feedback from one or more sensors related to the measured climate or air conditions present in the zone 104. If the measured climate conditions have not yet reached the target climate conditions, the zone 104 may continue to receive conditioned air, but the zone control panel 110 may instruct the one or more air dampers 108 associated with the zone 104 to adjust to a more closed position so that the airflow to the zone 104 is reduced. In some embodiments, for example, the zone control panel 110 may instruct HVAC equipment 106 to condition the zone 104 according to the normal procedure or may instruct the HVAC equipment 106 to condition the zone 104 according to the motion-based procedure for a detected motion.

Further, in some embodiments, the zone control panel 110 may return to condition the zone 104 based on the normal procedure after the duration has passed and no additional motion has been detected in the zone 104 or any other zones 104, while the zone control panel 110 may extend the duration of supplying the adjusted airflow and/or adjusted air conditioning to the zone 104 if additional motion is detected in the zone 104. Additionally or alternatively, once the measured climate conditions of the zone 104 are within a threshold of the expected climate conditions of the zone 104, the zone control panel 110 may modify and/or reduce airflow to the zone 104. For example, in some embodiments, regardless of whether additional motion has been detected in the zone 104, once the measured climate conditions of the zone 104 are within the threshold of the target climate conditions, the zone control panel 110 may instruct the one or more air dampers 108 in the zone 104 to close, which may reduce and/or substantially eliminate airflow to the zone 104. Additionally or alternatively, if an additional zone 104 having detected motion is in the process of receiving adjusted airflow and/or conditioned air, the zone control panel 110 may adjust the airflow to the zone 104 after a duration and/or the threshold of the target climate condition is reached to facilitate increasing airflow provided to the additional zone 104.

Accordingly, as described herein, once the airflow and/or air conditioning delivered to a zone 104 based at least in part on detected motion has been adjusted for a duration and/or until a threshold climate condition is reached, the zone control panel 110 may return to condition the zone 104 using the normal procedure to control operation of the HVAC equipment 106. Further, the zone control panel 110 may return to using the normal procedure in response to a programmable schedule, for example, which designates specific intervals during which the motion-based procedure may be used.

Further, while an HVAC system 100 featuring a number of zones 104 is described, in some embodiments, an occupancy sensor 102 may be implemented to detect motion in a non-zoned HVAC system 100. In such embodiments, the zone control panel 110 may generally follow the process 140 for controlling operation of the HVAC system 100 based on information received from one or more occupancy sensors 102. However, when motion is detected and a demand is present in the HVAC system 100, the zone control panel 110 may increase airflow and/or adjust the conditioning of the air delivered throughout the entire HVAC system 100 instead of to one or more zones 104 within the HVAC system 100. Further, in the normal procedure for controlling operation of HVAC equipment 106, the zone control panel 110 may condition the entire HVAC system 100 with a reduced airflow and/or level of conditioning of the air compared to the motion-based procedure.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A heating, ventilation, and air conditioning (HVAC) system comprising:
a first occupancy sensor configured to be disposed in a first zone of a building serviced by the HVAC system to indicate that the first zone is occupied when the first occupancy sensor detects occurrence of a first motion in the first zone followed by a second motion in the first zone that occurs within a first duration after the first motion; and
a zone control panel communicatively coupled to the first occupancy sensor and configured to control operation of equipment implemented in the HVAC system, wherein the zone control panel comprises a microcontroller programmed to:
determine whether a first difference between a first measured climate condition in the first zone and a first target climate condition associated with the first zone is greater than a difference threshold; and
when the first difference between the first measured climate condition and the first target climate condition is greater than the difference threshold:
instruct the equipment to provide first conditioned air produced by the HVAC system to the first zone at a first rate when the first occupancy sensor does not indicate that the first zone is occupied; and
instruct the equipment to provide the first conditioned air produced by the HVAC system to the first zone at a second rate greater than the first rate when the first occupancy sensor indicates that the first zone is occupied.

2. The HVAC system of claim 1, wherein, when the first difference is greater than the difference threshold and the first occupancy sensor indicates that the first zone is occupied, the microcontroller is programmed to:
instruct the equipment to provide the first conditioned air produced by the HVAC system to the first zone at a second rate until a duration threshold is reached;
determine whether a second difference between a second measured climate condition in the first zone measured after the duration threshold is reached and the first target climate condition associated with the first zone is greater than the difference threshold; and
instruct the equipment to provide second conditioned air produced by the HVAC system to the first zone at a third rate less than the second rate when the second difference between the second measured climate condition and the first target climate condition is greater than the difference threshold.

3. The HVAC system of claim 2, wherein the equipment comprises an HVAC unit configured to:
produce the first conditioned air by operating in a first conditioning stage; and
produce the second conditioned air by operating in a second conditioning stage.

4. The HVAC system of claim 1, wherein the equipment comprises:
an HVAC unit configured to configured to produce the first conditioned air; and
an air damper configured to be fluidly coupled between the HVAC unit and the first zone of the building, wherein the microcontroller is programmed to:
instruct the equipment to provide the first conditioned air to the first zone at the first rate by instructing the air damper to transition to, maintain, or both a first at least partially open position; and
instruct the equipment to provide the first conditioned air to the first zone at the second rate by instructing the air damper to transition to, maintain, or both a second at least partially open position that is greater than the first at least partially open position.

5. The HVAC system of claim 4, wherein the microcontroller is programmed to instruct the air damper to transition to, maintain, or both, a fully closed position when the first difference between the first measured climate condition and the first target climate condition is not greater than the difference threshold.

6. The HVAC system of claim 1, wherein the first occupancy sensor comprises a motion detector, an infrared sensor, an ultrasonic sensor, a camera, or any combination thereof.

7. The HVAC system of claim 1, comprising:
a zone thermostat configured to be disposed in the first zone of the building to enable setting the first target climate condition associated with the first zone, measuring the first measured climate condition in the first zone, or both via the zone thermostat, wherein the first occupancy sensor is integrated with the zone thermostat; and
a standalone occupancy sensor configured to be disposed in the first zone of the building to indicate that the first zone is occupied when the standalone occupancy sensor detects occurrence of a third motion in the first zone followed by a fourth motion in the first zone that occurs within the first duration after the third motion.

8. The HVAC system of claim 7, wherein the microcontroller is programmed to:
instruct the equipment to provide the first conditioned air produced by the HVAC system to the first zone at the first rate when the first occupancy sensor and the standalone occupancy sensor both do not indicate that the first zone is occupied; and
instruct the equipment to provide the first conditioned air produced by the HVAC system to the first zone at the second rate when the first occupancy sensor indicates that the first zone is occupied, the standalone occupancy sensor indicates that the first zone is occupied, or both.

9. The HVAC system of claim 1, comprising a second occupancy sensor configured to be disposed in a second zone of the building serviced by the HVAC system to indicate that the second zone is occupied when the second occupancy sensor detects occurrence of a third motion in the second zone followed by a fourth motion in the second zone that occurs within the first duration after the third motion, wherein:
the microcontroller is programmed to:
determine whether a second difference between a second measured climate condition in the second zone and a second target climate condition associated with the second zone is greater than the difference threshold; and
when the second difference between the second measured climate condition and the second target climate condition is greater than the difference threshold:
instruct the equipment to provide second conditioned air produced by the HVAC system to the second zone at a third rate when the second occupancy sensor does not indicate that the second zone is occupied; and
instruct the equipment to provide the second conditioned air produced by the HVAC system to the second zone at a fourth rate greater than the third rate when the second occupancy sensor indicates that the second zone is occupied.

10. The HVAC system of claim 9, wherein the microcontroller is programmed to instruct the equipment to provide the first conditioned air produced by the HVAC system to the first zone at the second rate and to provide the second conditioned air produced by the HVAC system to the second zone at the fourth rate such that the second rate is greater than the fourth rate when:
the first difference between the first measured climate condition and the first target climate condition is greater than the difference threshold;
the second difference between the second measured climate condition and the second target climate condition is greater than the difference threshold;
the first occupancy sensor indicates that the first zone is occupied;
the second occupancy sensor indicates that the second zone is occupied; and
the microcontroller determines that the first zone is more occupied than the second zone.

11. A method for controlling operation of equipment in a heating, ventilation, and air conditioning (HVAC) system, comprising:
indicating, using a first occupancy sensor configured to be disposed in a first zone of a building serviced by the HVAC system, that the first zone is occupied when the first occupancy sensor detects occurrence of a first motion in the first zone followed by a second motion in the first zone that occurs within a first duration after the first motion; and
determining, using one or more processors in the HVAC system, whether a first difference between a first measured climate condition in the first zone and a first target climate condition associated with the first zone is greater than a difference threshold; and
when the first difference between the first measured climate condition and the first target climate condition is greater than the difference threshold:
instructing, using the one or more processors, equipment in the HVAC system to provide first conditioned air produced by the HVAC system to the first zone at a first rate when the first occupancy sensor does not indicate that the first zone is occupied; and
instructing, using the one or more processors, the equipment to provide the first conditioned air produced by the HVAC system to the first zone at a second rate greater than the first rate when the first occupancy sensor indicates that the first zone is occupied.

12. The method of claim 11, comprising:
instructing, using the one or more processors, the equipment to provide the first conditioned air to the first zone at the second rate until a second difference between a second measured climate condition in the first zone measured after the first measured climate condition is not greater than the difference threshold; and
when the second difference is not greater than the difference threshold:
instructing, using the one or more processors, the equipment to provide no conditioned air to the first zone.

13. The method of claim 11, comprising:
determining, using the one or more processors, that the first difference is not greater than the difference threshold; and
instructing, using the one or more processors, the equipment to provide no conditioned air to the first zone when first occupancy sensor does not indicate that the first zone is occupied or when the first occupancy sensor indicates that the first zone is occupied.

14. The method of claim 11, comprising:
indicating, using a first occupancy sensor, that the first zone is occupied when the first occupancy sensor detects occurrence of the first motion in the first zone and a second occupancy sensor configured to be disposed in the first zone detects occurrence of the second motion in the first zone that occurs within the first duration after the first motion.

15. The method of claim 11, comprising:
indicating, using a second occupancy sensor configured to be disposed in a second zone of the building serviced by the HVAC system, that the second zone is occupied when the second occupancy sensor detects occurrence of a third motion in the second zone followed by a fourth motion in the second zone that occurs within the first duration after the third motion; and
determining, using the one or more processors, whether a second difference between a second measured climate condition in the second zone and a second target climate condition associated with the second zone is greater than the difference threshold; and
when the second difference between the second measured climate condition and the second target climate condition is greater than the difference threshold:
instructing, using the one or more processors, the equipment to provide second conditioned air produced by the HVAC system to the second zone at a third rate when the second occupancy sensor does not indicate that the second zone is occupied; and
instructing, using the one or more processors, the equipment to provide the second conditioned air produced by the HVAC system to the second zone at a fourth rate greater than the third rate when the first occupancy sensor indicates that the second zone is occupied.

16. The method of claim 15, comprising:
instructing, using the one or more processors, the equipment to provide the first conditioned air produced by the HVAC system to the first zone at the second rate and to provide the second conditioned air produced by the HVAC system to the second zone at the fourth rate such that the second rate is greater than the fourth rate when:
the first difference between the first measured climate condition and the first target climate condition is greater than the difference threshold;
the second difference between the second measured climate condition and
the second target climate condition is greater than the difference threshold;
the first occupancy sensor indicates that the first zone is occupied;
the second occupancy sensor indicates that the second zone is occupied; and
the one or more processors determine that the first zone is more occupied than the second zone.

17. The method of claim 11, comprising:
when the first difference is greater than the difference threshold and the first occupancy sensor indicates that the first zone is occupied:
instructing, using the one or more processors, the equipment to provide the first conditioned air produced by the HVAC system to the first zone at a second rate until a duration threshold is reached;
determining, using the one or more processors, whether a second difference between a second measured climate condition in the first zone measured after the duration threshold is reached and the first target climate condition associated with the first zone is greater than the difference threshold; and
instructing, using the one or more processors, the equipment to provide second conditioned air produced by the HVAC system to the first zone at a third rate less than the second rate when the second difference between the second measured climate condition and the first target climate condition is greater than the difference threshold.

18. A tangible, non-transitory, computer-readable medium, comprising instructions executable by at least one processor of a control system in a heating, ventilation, and air conditioning (HVAC) system that, when executed by the at least one processor, cause the at least one processor to:
determine whether a first occupancy sensor indicates that a first zone of a building serviced by the HVAC system is occupied, wherein the first occupancy sensor is configured to be disposed in the first zone and to indicate that the first zone is occupied when the first occupancy sensor detects occurrence of a first motion in the first zone followed by a second motion in the first zone within a first duration after the first motion; and
determine whether a first difference between a first measured climate condition in the first zone and a first target climate condition associated with the first zone is greater than a difference threshold; and
when the first difference between the first measured climate condition and the first target climate condition is greater than the difference threshold:
instruct equipment in the HVAC system to provide first conditioned air produced by the HVAC system to the first zone at a first rate when the first occupancy sensor does not indicate that the first zone is occupied; and
instruct the equipment to provide the first conditioned air produced by the HVAC system to the first zone at a second rate greater than the first rate when the first occupancy sensor indicates that the first zone is occupied.

19. The computer-readable medium of claim 18, wherein the instructions, when executed by the at least one processor, cause the at least one processor to:
determine, when the first occupancy sensor does not indicate that the first zone is occupied, that the difference threshold is equal in value to a first threshold; and
determine, when the first occupancy sensor indicates that the first zone is occupied, that the difference threshold is equal in value to a second threshold, wherein the second threshold is less than the first threshold.

20. The computer-readable medium of claim 18, wherein the instructions, when executed by the at least one processor, cause the at least one processor to:
when the first difference between the first measured climate condition and the first target climate condition is greater than the difference threshold:
instruct the equipment to provide first conditioned air to the first zone at a first rate when the first occupancy sensor does not indicate that the first zone is occupied; and
instruct the equipment to provide second conditioned air produced by the HVAC system to the first zone at a second rate greater than the first rate when the first occupancy sensor indicates that the first zone is occupied.
